(19) United States
(12) Patent Application Publication
(10) Pub. No.: US 2018/0222446 A1
(43) Pub. Date: Aug. 9, 2018

(54) DOOR MOUNTED SCANNING APPARATUS

(71) Applicant: Gentex Corporation, Zeeland, MI (US)

(72) Inventor: Nigel T. Lock, Holland, MI (US)

(73) Assignee: Gentex Corporation, Zeeland, MI (US)

(21) Appl. No.: 15/889,256

(22) Filed: Feb. 6, 2018

Related U.S. Application Data
(60) Provisional application No. 62/456,355, filed on Feb. 8, 2017.

(51) Int. Cl. B60R 25/30; G06K 9/00; H04N 5/33; H04N 5/225; B60R 1/06; B60R 1/12; B60R 25/01

(52) U.S. Cl. CPC B60R 25/305; G06K 9/00604; H04N 5/33; H04N 5/2256; B60R 1/06; B60R 2300/8073; B60R 25/01; B60R 2001/1223; B60R 2001/1253; B60R 2300/103; B60R 1/12

(57) ABSTRACT

A scanning apparatus is disposed on a vehicle and included an external rearview assembly having a housing and an electro-optic element. The electro-optic element includes a first substrate comprising a first surface and a second surface. The electro-optic element also includes a second substrate comprising a third surface and a fourth surface, wherein the first substrate and the second substrate define a cavity. An electro-optic medium is contained in the cavity. An image sensor is disposed on the housing and directed outward, the image sensor configured to capture biometric data from an individual that is processed by a controller to unlock a door of the vehicle.

### CROSS-REFERENCE TO RELATED APPLICATION

This application claims priority to and the benefit under 35 U.S.C. § 119(e) of U.S. Provisional Application No. 62/456,355, filed on Feb. 8, 2017, entitled “DOOR MOUNTED SCANNING APPARATUS,” the disclosure of which is hereby incorporated herein by reference in its entirety.

### TECHNOLOGICAL FIELD

The present invention generally relates to a scanning apparatus, and more particularly, to a door mounted scanning apparatus that may include iris identification.

### SUMMARY OF THE DISCLOSURE

In one aspect of the present disclosure, a scanning apparatus is disposed on a vehicle and includes an external rearview assembly having a housing and an electro-optic element. The electro-optic element includes a first substrate having a first surface and a second surface. The electro-optic element also includes a second substrate having a third surface and a fourth surface, wherein the first substrate and the second substrate define a cavity. An electro-optic medium is contained in the cavity. An image sensor is disposed on the housing and directed outward. The image sensor is configured to capture biometric data from an individual that is processed by a controller to unlock a door of the vehicle.

In another aspect of the present disclosure, a scanning apparatus is disposed on a vehicle. An external rearview assembly includes a dimmable electro-optic element. A light source is configured to emit light in a near infrared (NIR) range to illuminate a face of the individual. An image sensor is operably coupled with the electro-optic element. The image sensor is configured to capture biometric data from the individual. The captured biometric data is processed by a controller to unlock a door of the vehicle. A display is disposed in the external rearview assembly behind the electro-optic element. The captured biometric data is presented on the display.

In yet another aspect of the present disclosure, a scanning apparatus is disposed on a vehicle. An external rearview assembly includes a dimmable electro-optic element. An image sensor is operably coupled with and is spaced from the electro-optic element. The image sensor is configured to capture biometric data from an individual that is processed by a controller to unlock a door of the vehicle. A light source is configured to emit light in a near infrared (NIR) range to illuminate an eye of the individual.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a side perspective view of a vehicle of the present disclosure including a door assembly having a scanning apparatus;

FIG. 2 is a side elevational view of the door assembly of FIG. 1;

FIG. 3 is an enlarged side perspective view of a scanning device on the door assembly of FIG. 1;

FIG. 4 is an enlarged side perspective exploded view of an external rearview assembly and scanning device of FIG. 3;

FIG. 4A is a side cross-sectional view of an electro-optic element of the present disclosure;

FIG. 5 is a side elevational view of another scanning apparatus of the present disclosure;

FIG. 6 is a side perspective exploded view of the scanning apparatus of FIG. 5; and

FIG. 7 is a block diagram of a vehicle control module in communication with a scanning apparatus of the present disclosure.

### DETAILED DESCRIPTION

The present illustrated embodiments reside primarily in combinations of method steps and apparatus components related to a door mounted scanning apparatus. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

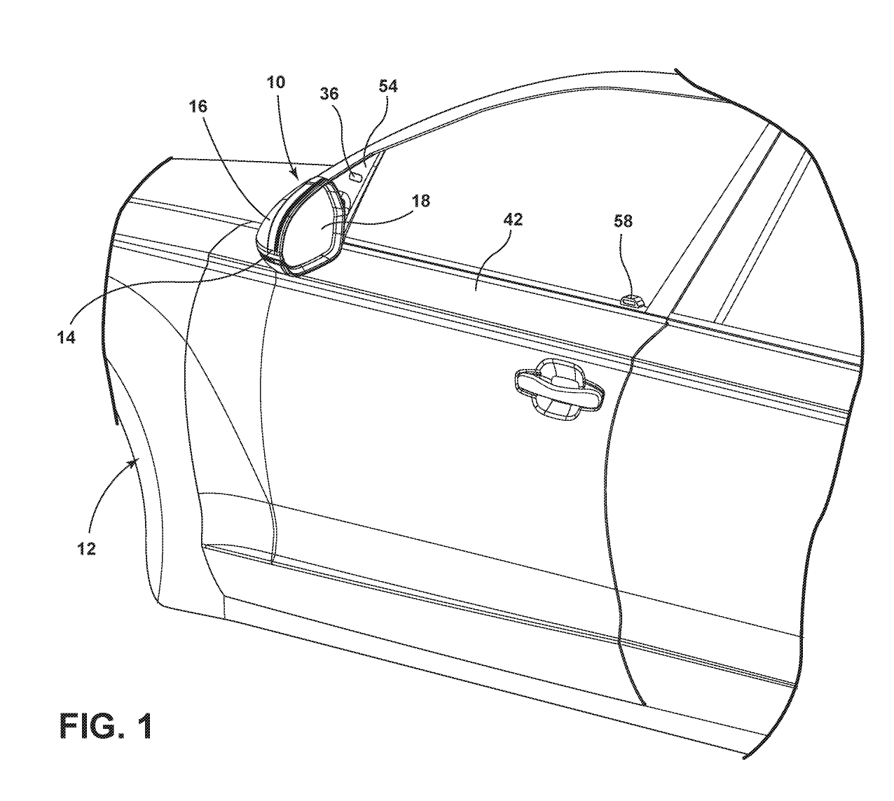

For purposes of description herein, the terms “upper,” “lower,” “right,” “left,” “rear,” “front,” “vertical,” “horizontal,” and derivatives thereof shall relate to the invention as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

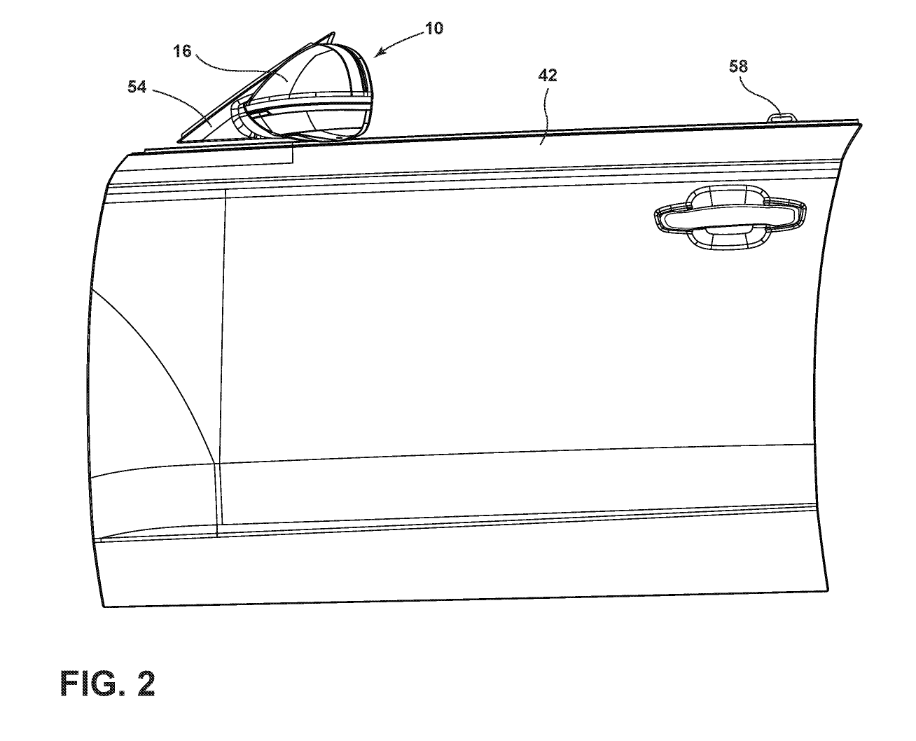

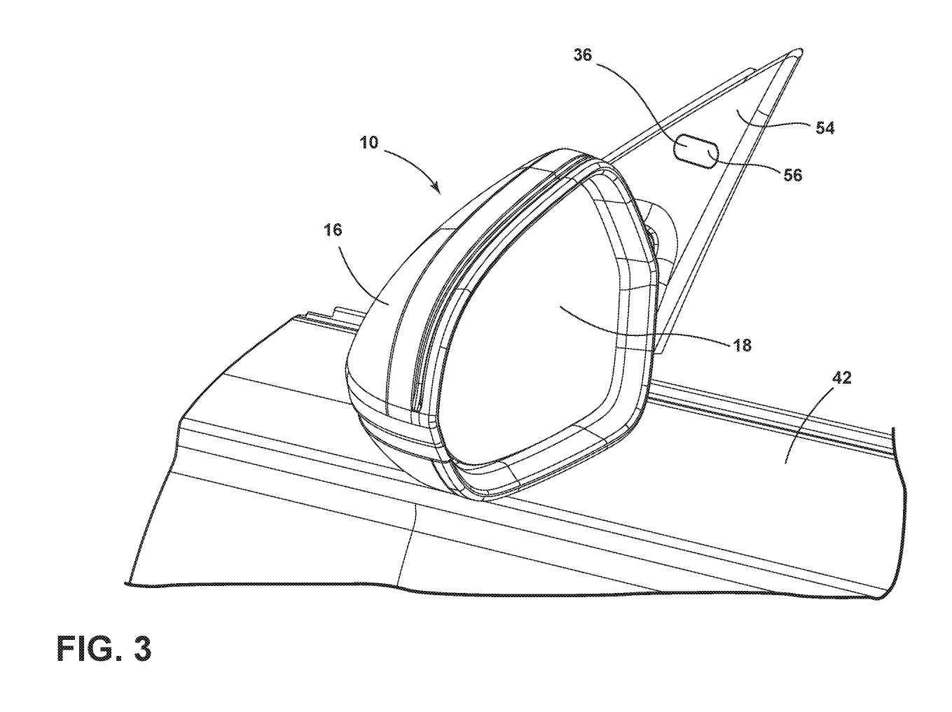

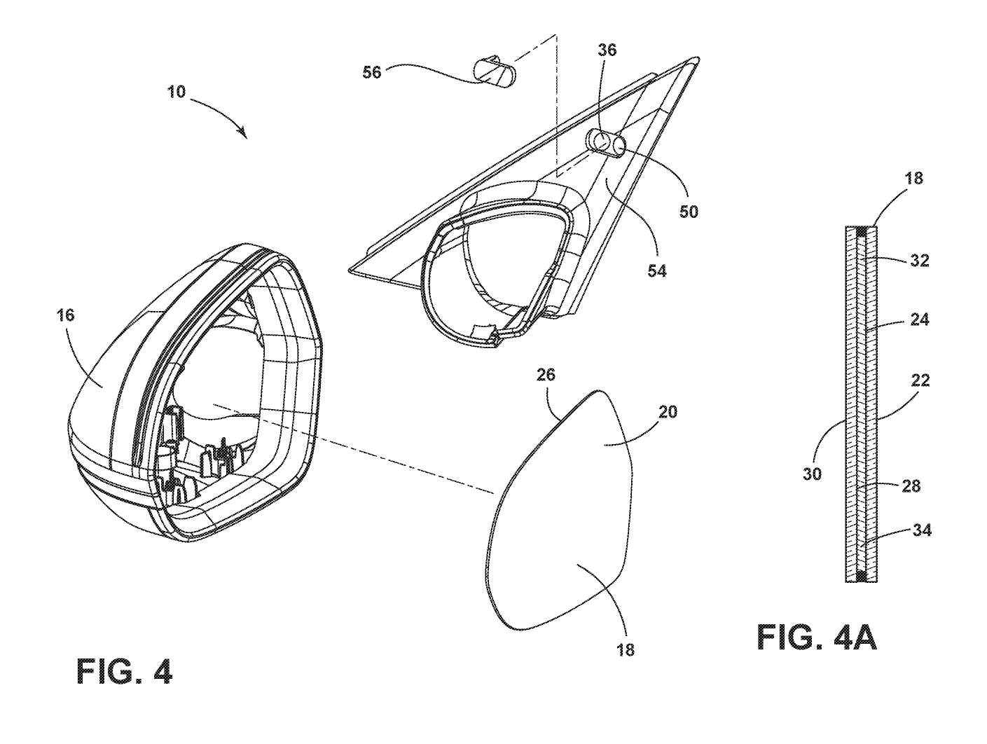

Referring to FIGS. 1-7, the reference numeral 10 generally designates a scanning apparatus disposed on a vehicle 12 that includes an external rearview assembly 14 having a housing 16 and an electro-optic element 18. The electro-optic element 18 includes a first substrate 20 defining a first surface 22 and a second surface 24. The electro-optic element 18 also includes a second substrate 26 defining a third surface 28 and a fourth surface 30, wherein the first substrate 20 and the second substrate 26 define a cavity 32. An electro-optic medium 34 is contained within the cavity 32. An image sensor 36 is disposed on the housing 16 and is directed outward. The image sensor 36 is configured to capture biometric data from an individual that is processed by a controller 40 to unlock a door 42 of the vehicle 12.

To provide for the eye-scan-identification function, for example, a face, eye, or iris scan, the image sensor 36 is directed upward in a predetermined direction toward the eyes of an individual outside the vehicle 12 proximate a window of the door 42. The image sensor 36 may include, for example, a digital charge-coupled device (CCD) or complementary metal-oxide-semiconductor (CMOS) active pixel sensor, although not limited to these exemplary devices. The image sensor 36 may be in communication with at least one light source 50, which may correspond to one or more infrared emitters configured to output an emission of light in the near infrared (NIR) range. In this configuration, the image sensor 36 may be configured to selectively activate the one or more infrared emitters corresponding to the at least one light source 50 to illuminate the face, eye, or iris of an individual such that an identity of an individual seeking entry into the vehicle 12 may be determined. The eye-scan-identification function may utilize an infrared illumination of an iris of an eye in order to illuminate the eye for the identification. Such illumination may be optimized in conditions allowing for a high optical transmittance in the NIR range. It is generally contemplated that the light source 50 may be disposed proximate the image sensor 36 behind a lens 56. The lens 56 may include dimmable electro-optic features. Alternatively, the light source 50 may be disposed behind the electro-optic element 18. In either instance, an electrochromic (EC) stack of the electro-optic element 18 or the lens 56 may have a high light transmittance in the NIR range, for example, wavelengths ranging from 810 nm to 850 nm in the optical spectrum. Additionally, in some implementations, the electro-optic assembly may include a plurality of light sources configured to illuminate at least one iris of the operator of the vehicle 12. Optionally, the light source 50 may include a light emitter disposed behind the electro-optic element 18 and another light emitter disposed in or on the housing 16 or a sail panel 54. The light emitters may operate individually to illuminate the face, eye, or iris of an individual, depending on where the individual is standing, or may work in concert to illuminate the face, eye, or iris of the individual.

With reference to FIGS. 1-4A, the illustrated scanning apparatus 10 is illustrated with the sail panel 54 operably coupled with the housing 16. It will be understood that the sail panel 54 may be integrally formed with the housing 16 or may be a separate item mechanically attached with the housing 16. As illustrated, the image sensor 36 of the scanning apparatus 10 includes a lens 56 coupled with the sail panel 54. It will be understood that the lens 56 may protrude outwardly from the sail panel 54, or may be flush with the sail panel 54. Further, the lens 56 may be recessed within the sail panel 54. Regardless, the lens 56 provides optical communication of the image sensor 36 with the environment. Accordingly, an individual can look or gaze at the lens 56 to provide characterizing information about the individual to the image sensor 36. It will also be understood that the light source 50 may be disposed behind the lens 56 adjacent to the image sensor 36, or may be positioned elsewhere on or near the sail panel 54 of the housing 16. The light source 50 is configured to illuminate unique biometric features of an individual (such as the face, eye, or iris of an individual), so that biometric data can be properly gathered by the image sensor 36.

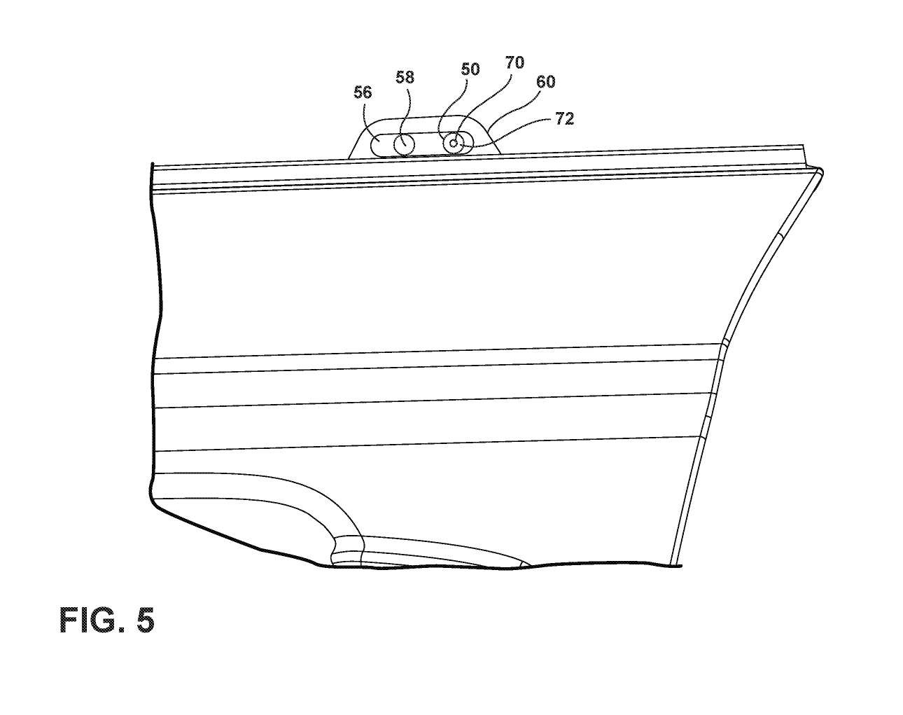

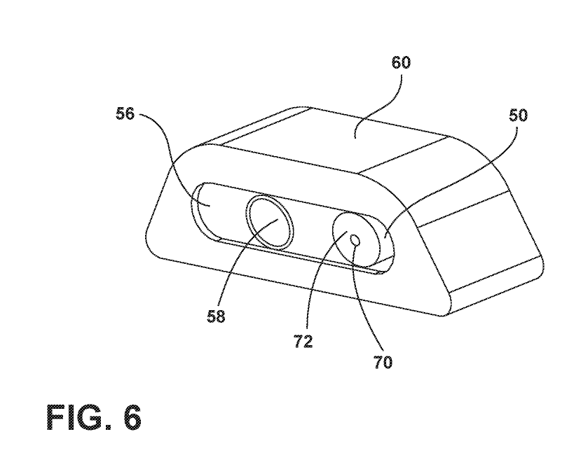

FIGS. 5 and 6 illustrate an image sensor 58, which may be a secondary image sensor, that is spaced from, but may be in electrical communication with, the external rearview assembly 14. In this instance, the image sensor 58 includes a housing 60 that may be formed as part of a panel of the door 42, or operably coupled with the panel of the door 42. The housing 60 protects the image sensor 58 from dirt and debris, as well as damage from the environment. A front surface of the image sensor 58 includes the lens 56 that protects the image sensor 58 and possibly the light source 50 disposed within the housing 60. As previously noted, the lens 56 may have dimmable electro-optic features. It will be understood that the image sensor 58 may correspond with the external rearview assembly 14 wirelessly or via a wired connection through the panel of the door 42. It will also be understood that the image sensor 58 assembly, as illustrated in FIGS. 5 and 6, may be supplied from an aftermarket source or by an original equipment manufacturer (OEM).

The infrared emitters or the light sources 50 may correspond to a single emitter 70 or a plurality of infrared emitters 70, 72. Each of the infrared emitters 70, 72 may include a plurality of light emitting diodes, which may be grouped in a matrix or otherwise grouped and disposed behind a rear surface of the electro-optic element 18. In this configuration, the scanning apparatus 10 may be configured to illuminate a unique biometric feature of an individual, such as the face, eyes, or irises of an individual, such that the image sensors 36, 58 may capture an image of the unique biometric feature. In an exemplary embodiment, the emitter 70 may emit light in the visible range, while the emitter 72 may emit light in the NIR range. The light sources 50 may be configured to operate independently or together so that the image sensor 58 can sufficiently collect image data in relation to unique biometric features on an individual attempting to access the vehicle 12.

The image sensors 36, 58 may be disposed on a circuit board, for example, a printed circuit board (PCB), in communication with the controller 40. The controller 40 may further be in communication with various devices that may be incorporated in the vehicle 12 via a communication bus or any other suitable communication interface. The controller 40 may correspond to one or more processors or circuits, which may be configured to process image data received from the image sensors 36, 58. In this configuration, the image data may be communicated from the image sensors 36, 58 to the controller 40. The controller 40 may process the image data with one or more algorithms configured to determine an identity of the individual attempting to access the vehicle 12.

The controller 40 may be in communication with an indicator 68 that relays to the individual whether the scan was completed and access will be granted, completed and access will be denied, or not completed and denied. The indicator 68 may be disposed in the electro-optic element 18, on the housings 16, 60 of the external rearview assembly 14, or adjacent to the electro-optic element 18. The indicator 68 may be in communication with the controller 40 and configured to output a signal to identify an operation state of the scanning apparatus 10 and/or a rearview camera. The indicator 68 may include a light source that may be operable to flash and/or change colors to communicate a state of the scanning apparatus 10. The indicator 68 may include a light-emitting diode (LED), and in an exemplary embodiment, the indicator 68 may include a red, green, and blue (RGB) LED operable to identify the operation state of the scanning apparatus 10 by outputting one or more colored emissions of light. The indicator 68 may be operably coupled with an audible indicator that may provide a sound or sounds related to whether the scan was completed and access will be granted, completed and access will be denied, or not completed and denied. The indicator 68 may also show or indicate if the scan is complete, but access may be denied if the individual is not identified. The indicator 68 may also indicate, after access is granted to the vehicle 12, that a particular operator has been granted access. Accordingly, any presets related to mirror, steering wheel, seat positions, and entertainment systems, for example, will be adjusted to accommodate the detected operator.

It is also contemplated that the controller 40 may be operable to display the image data received from the image sensors 36, 58 on a display 70 disposed within the external rearview assembly 14 behind the electro-optic element 18 such that the operator may view the image data. In this configuration, the individual may adjust a position of the eyes shown on the display 70 to position the eyes such that image data related to unique or distinct characteristics of the eyes of the individual can be captured by one or more of the image sensors 36, 58. In an exemplary embodiment, the features required to identify the operator of the vehicle 12 may correspond to features of the eyes of the operator (e.g., face, eyes, irises, etc.).

The display 70 may correspond to a partial or full display exterior mirror configured to display image data through at least a portion of the electro-optic element 18. The display 70 may be constructed utilizing various technologies, for example, liquid crystal display (LCD), LED, organic light-emitting diode (OLED), plasma, digital light processing (DLP), or other display technology. Examples of display assemblies that may be utilized with the disclosure may include U.S. Pat. No. 6,572,233, entitled “Rearview display mirror”; U.S. Pat. No. 8,237,909, entitled “Vehicular rearview scanning apparatus including integrated backlighting for a liquid crystal display (LCD)”; U.S. Pat. No. 8,411,245, entitled “Multi-display mirror system and method for expanded view around a vehicle”; and U.S. Pat. No. 8,339,526, entitled “Vehicle rearview scanning apparatus including a high intensity display,” which are incorporated herein by reference in their entirety.

The electro-optic element 18 may be partially reflective and partially transmissive and include a mirror element that reflects a rearward view behind the vehicle back to the driver. The cavity 32 may contain an electro-optic medium 34, such as, but not limited to, an electrochromic medium. The cavity 32 may be completely or partially filled with the electro-optic medium. The scanning apparatus 10 may be in communication with a dimming controller via electrical contacts and may include various seals to retain the electro-optic medium 34 in the cavity 32. In this configuration, the scanning apparatus 10 may be configured to vary in reflectance in response to a control signal received from the dimming controller via the electrical contacts. In one example of an electro-optic assembly, a transflective coating is disposed on the third surface 28 and may generally be metal-based with a nominal reflectance of 65% and a nominal transmittance of 22% in the visible range.

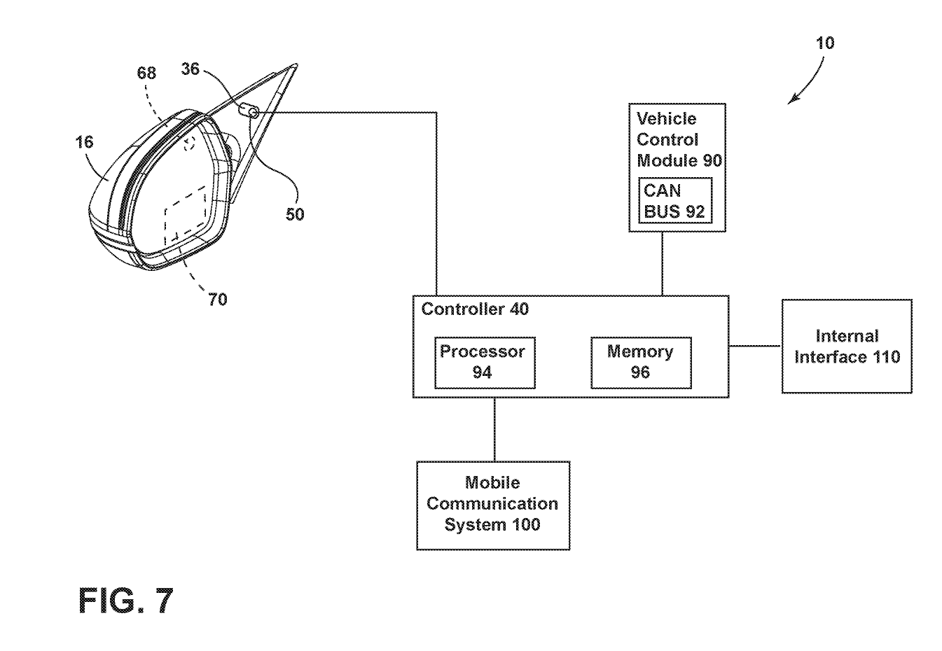

Referring now to FIG. 7, a block diagram of functionality of an embodiment of the scanning apparatus 10 is illustrated. The controller 40 is shown in communication with the scanning apparatus 10 and may also be in communication with a vehicle control module 90 via a communication bus 92 of the vehicle 12. The communication bus 92 may be configured to deliver signals to the controller 40 identifying various vehicle states. For example, the communication bus 92 may be configured to communicate to the controller 40 a drive selection of the vehicle 12, an ignition state, a door open or ajar status, or a remote activation of the scanning apparatus 10. Such information and control signals may be utilized by the controller 40 to activate or adjust various states and/or control schemes of the scanning apparatus 10 and/or the external rearview assembly 14.

The controller 40 may include a processor 94 having one or more circuits configured to receive the signals from the communication bus 92 and control the scanning apparatus 10. The processor 94 may be in communication with a memory 96 configured to store instructions to control operations of the scanning apparatus 10. For example, the controller 40 may be configured to store one or more characteristics or profiles of individuals that is utilized by the controller 40 to identify the operator of the vehicle 12. In this configuration, the controller 40 may communicate operating and identification information with the scanning apparatus 10 to identify the individual being scanned. Additionally, based on the identification of the individual, the controller 40 may be configured to control and/or communicate with additional systems of the vehicle 12.

In an exemplary embodiment, the controller 40 may correspond to one or more processors or circuits. The controller 40 may be configured to process image data received from the image sensors 36, 58. In this configuration, the controller 40 may process the image data with one or more algorithms configured to determine an identity of the individual attempting to access the vehicle 12. After the individual has been identified, the controller 40 may further be operable to control various systems or functions of the vehicle 12 based on the identification of the individual.

For example, the controller 40 may be configured to authorize various settings or restrictions of settings for the vehicle 12 based on the identification of certain individuals. The authorization may correspond to a speed governor, a payment authorization for toll roads, a log of use and operation time, seat position settings, infotainment system settings, comfort and climate control settings, etc. In some implementations, the scanning apparatus 10 may also be configured to document information corresponding to use of the vehicle 12 and for how long, for example, the number of passengers, a top speed of the vehicle, a maximum rate of acceleration, etc. In some embodiments, the controller 40 may further be in communication with a global position system (GPS) that may also provide regional restrictions for the operation of the vehicle 12.

The controller 40 may utilize the identification of the operator of the vehicle 12 to report updates to an administrator of the vehicle 12. For example, it is contemplated that the controller 40 may be in communication with a mobile communication system 100. The mobile communication system 100 may be configured to communicate via various mobile communication protocols. Wireless communication protocols may operate in accordance with communication standards including, but not limited to: Institute of Electrical and Electronic Engineering (IEEE) 802.11 (e.g., WiFi™); Bluetooth®; advanced mobile phone services (AMPS); digital AMPS; global system for mobile communications (GSM); code division multiple access (CDMA); Long Term Evolution (LTE or 4G LTE); local multi-point distribution systems (LMDS); multi-channel-multi-point distribution systems (MMDS); radio-frequency identification (RFID); and/or variations thereof. In this configuration, the controller 40 may be configured to send an alert or message to the administrator of the vehicle in response to one or more predetermined event. The alert or message may correspond to a text message, data message, email, alert via an application operating on a smart device, etc.

A predetermined event may correspond to a wide variety of events that may be identified by the controller 40 based on an identity of an operator of the vehicle 12 via the image sensors 36, 58 of the scanning apparatus 10. For example, the event may correspond to the vehicle 12 crossing a geographic boundary, an ignition event identifying vehicle operation, operation during a restricted usage time (e.g., a time between midnight and 5 am), an identification of a number of passengers in the vehicle 12 exceeding a predefined limit, etc. In this configuration, the controller 40 may identify a restricted user of the vehicle 12 via the scanning apparatus 10 and provide notifications to the administrator.

In some embodiments, the controller 40 may also report that an unauthorized individual is attempting to access the vehicle 12. This may be due to a malfunction or a deliberate attempt to avoid identification from the scanning apparatus 10. In response to operation or attempted operation of the vehicle 12 without identification, the administrator of the vehicle 12 may be notified via a message submitted from the mobile communication system 100 reporting unauthorized or otherwise unfavorable activity of the vehicle 12. In this configuration, the administrator of the vehicle 12 may be notified of any form of restricted activity that may be identified by the controller 40 corresponding to a restricted or unidentified individual attempting to access the vehicle 12.

The controller 40 may further be in communication with an internal interface 110 configured to receive one or more inputs that control the scanning apparatus 10. In some embodiments, an interface may be combined with one or more devices of the vehicle 12. For example, the internal interface 110 may form a portion of a gauge cluster, the A/V system, the infotainment system, a display console and/or various input/output devices that may commonly be utilized in automotive vehicles (e.g., a steering switch, steering wheel controls, etc.). In this way, the disclosure provides for various control schemes for implementing the scanning apparatus 10 in a vehicle.

The external rearview assembly 14 may include the electro-optic element 18, a prism element, etc. One non-limiting example of the electro-optic element 18 includes the electro-optic medium 34, which has at least one solvent, at least one anodic material, and at least one cathodic material. Generally, both of the anodic and cathodic materials are electroactive and at least one of them is electrochromic. Additionally, it will be understood that the term “electrochromic” will be defined herein, regardless of its ordinary meaning, as a material that exhibits a change in its extinction coefficient at one or more wavelengths upon exposure to a particular electrical potential difference. Electrochromic components, as described herein, include materials whose color or opacity are affected by electric current, such that when an electrical current is applied to the material, the color or opacity change from a first phase to a second phase. The electrochromic component may be a single-layer, single-phase component, multi-layer component, or multi-phase component, as described in U.S. Pat. No. 5,928,572, entitled “Electrochromic Layer And Devices Comprising Same”; U.S. Pat. No. 5,998,617, entitled “Electrochromic Compounds”; U.S. Pat. No. 6,020,987 entitled “Electro-optic medium Capable Of Producing A Pre-selected Color”; U.S. Pat. No. 6,037,471, entitled “Electrochromic Compounds”; U.S. Pat. No. 6,141,137, entitled “Electrochromic Media For Producing A Pre-selected Color”; U.S. Pat. No. 6,249,369, entitled “Coupled Electrochromic Compounds With Photostable Dication Oxidation States”; and U.S. Pat. No. 6,137,620, entitled “Electrochromic Media With Concentration Enhanced Stability, Process For The Preparation Thereof and Use In Electrochromic Devices,” which are herein incorporated by reference in their entirety. The electro-optic element 18 may also be any other element having partially reflective, partially transmissive properties.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A scanning apparatus disposed on a vehicle comprising:
an external rearview assembly comprising:
a housing;
an electro-optic element comprising:
a first substrate comprising a first surface and a second surface;
a second substrate comprising a third surface and a fourth surface,
wherein the first substrate and the second substrate define a cavity;
an electro-optic medium contained in the cavity; and
an image sensor disposed on the housing and directed outward, the image sensor configured to capture biometric data from an individual that is processed by a controller to unlock a door of said vehicle.

2. The scanning apparatus of claim 1, further comprising:
a display disposed in the external rearview assembly behind the electro-optic element.

3. The scanning apparatus of claim 2, wherein the captured biometric data is presented on the display.

4. The scanning apparatus of claim 1, wherein the image sensor includes a lens disposed on a sail panel of the housing.

5. The scanning apparatus of claim 1, wherein the captured biometric data corresponds to distinct eye characteristics of the individual.

6. The scanning apparatus of claim 1, further comprising:
a light source configured to emit light in a near infrared (NIR) range to illuminate an eye of the individual.

7. The scanning apparatus of claim 6, wherein the light source is disposed behind the electro-optic element.

8. The scanning apparatus of claim 1, further comprising:
an indicator configured to show an operation state of the image sensor.

9. The scanning apparatus of claim 1, further comprising:
a secondary image sensor disposed on the door of said vehicle.

10. A scanning apparatus disposed on a vehicle comprising:
an external rearview assembly having a dimmable electro-optic element;
a light source configured to emit light in a near infrared (NIR) range to illuminate a face of an individual;
an image sensor operably coupled with the electro-optic element, the image sensor configured to capture biometric data from the individual, wherein the captured biometric data is processed by a controller to unlock a door of said vehicle; and
a display disposed in the external rearview assembly behind the electro-optic element, and wherein the captured biometric data is presented on the display.

11. The scanning apparatus of claim 10, wherein the image sensor is disposed proximate a window of the door.

12. The scanning apparatus of claim 10, wherein the captured biometric data corresponds to distinct eye characteristics of the individual.

13. The scanning apparatus of claim 10, wherein the light source is disposed behind the electro-optic element.

14. The scanning apparatus of claim 10, further comprising:
an indicator configured to show an operation state of the image sensor.

15. A scanning apparatus disposed on a vehicle comprising:
an external rearview assembly having a dimmable electro-optic element;
an image sensor operably coupled with and spaced from the electro-optic element, the image sensor configured to capture biometric data from an individual that is processed by a controller to unlock a door of said vehicle; and
a light source configured to emit light in a near infrared (NIR) range to illuminate an eye of the individual.

16. The scanning apparatus of claim 15, wherein the captured biometric data corresponds to distinct eye characteristics of the individual.

17. The scanning apparatus of claim 15, wherein the light source is disposed behind the electro-optic element.

18. The scanning apparatus of claim 15, further comprising:
an indicator configured to show an operation state of the image sensor.

19. The scanning apparatus of claim 15, wherein the image sensor is disposed proximate a window of the door.
